(19) United States
(12) Patent Application Publication
(10) Pub. No.: US 2012/0204432 A1
(43) Pub. Date: Aug. 16, 2012

(54) Handle Part for a Motorized Handheld Tool

(75) Inventors: Pär Martinsson, Jonkoping (SE); Rajinder Mehra, Johannshov (SE); Håkan Fransson, Jonkoping (SE)

(73) Assignee: HUSQVARNA AB, Huskvarna (SE)

(21) Appl. No.: 13/503,422

(22) PCT Filed: Oct. 23, 2009
(86) PCT No.: PCT/SE2009/051214

§ 371 Date: Apr. 23, 2012

(51) Int. Cl. B27B 17/00; B25G 1/10; B25F 5/02

(52) U.S. Cl. 30/517

(57) ABSTRACT

The present invention relates to a handle part (20) for a motorized, handheld tool (10), having at least one handle (21, 22), for an operator to carry and operate the tool (10), said handle part (20) further having at least one base portion (23) arranged adjacent said at least one handle (21, 22) in such a way that a toe portion, of a boot or the like of an operator, may be held against the base portion (23) when the tool (10) is placed on the ground.

Said handle part (20) further having at least one rear portion (24) arranged where the base plate (23) and said at least one handle (21, 22) meet, in such a way that a thigh of an operator may be held against the rear portion (23) when operating the tool (10).

At least one of, the base portion (23) and the rear portion (24), is provided with at least one support means (231, 241) in order to facilitate the handling of the tool (10), in such a way that, an operator, more easily, can operate the tool (10) and more easily can keep the tool (10) in place on the ground when, for example, starting or adjusting the tool (10).

### TECHNICAL FIELD

The present disclosure relates to a handle part for a motorized handheld tool, such as a chain saw, said handle part having at least on handle for an operator to carry and operate the tool.

The handle part further having at least one base portion arranged adjacent said handle in such a way that a toe portion, of a boot or the like of an operator, may be held against the base portion when the tool is placed on the ground.

The handle part further having at least one rear portion arranged where the base plate and the handle meet, in such a way that a thigh of an operator may be held against the rear portion when operating the tool.

### BACKGROUND

Handle parts for motorized, handheld tool, such as chain saws, are often manufactured by injection moulding in two separate parts, which are not necessarily identical, but which are intended to be joined together along a circumferential line. The method of joining the two parts of the handle part is in general vibration welding, which includes a series of vibrations with high frequency and low amplitude, resulting in a joint along the circumferential line.

Since vibration welding of two pieces requires a sufficient thickness of the material to be welded, the walls of the handle part in several places have greater thickness in the area of the joint. This will in turn mean that the weld will in several places be located at a circumferential protuberance, extending a distance from the surrounding surfaces. Especially on the underside of the handle part this means that there is a protruding ridge, the weld, along the underside of the handle member, i.e. on the underside of the tool.

There are two safe ways for an operator to start for example a chain saw, on the ground or holding the saw between your legs. When starting the chain saw on the ground this protruding ridge can make the starting procedure difficult, since the chain saw tends to lean over towards one side when placing the tool on the ground and this often results in that the tool does not stand in a steady position. When adjusting the chain saw it can also be useful to place it steady on the ground.

It is possible for an operator to place one foot or toe portion of a boot, in the rear handle and hold the front handle steady with the left hand, when pull starting the start handle. But, usually the space in the rear handle is not big enough for a boot of an operator to fit in there.

Another problem that the protruding ridge may cause is when the operator is cutting a log from below, using undercut, the operator then has to lift/raise the chain saw up towards the log in order to control/adjust the feeding pressure. This is very tiring and the operator therefore needs to support the saw with the body in order to relieve the pressure on back, shoulders and arms.

It is possible for an operator to use, for example, the right thigh in order to push the chain saw in the rear part of the tank. But, a problem with available tanks today is that the rear part of the tank consists of said protuberance in the area of the weld. This protuberance increases the risk that the chain saw might slip off the thigh of the operator and the protuberance might also cause an uncomfortable pressure on the thigh.

Hence, there is a need for a handle part for a motorized, handheld tool which handle part, in an easy and comfortable way, make is possible to start or adjust the tool on the ground and which handle part also make it possible to operate using undercut in an easy and comfortable way.

### SUMMARY OF THE INVENTION

In order to solve the above problems a handle part according to the preamble of claim 1 is provided and which is characterized in that;

at least one of, the base portion and the rear portion, is provided with at least one support means in order to facilitate the handling of the tool, in such a way that, an operator, more easily, can operate the tool and more easily can keep the tool in place on the ground when, for example, starting or adjusting the handheld tool. By arranging the base plate and/or the rear portion with support means the operator can handle the tool in a stable way without slipping.

By arranging the support means of the base portion with a first friction means in order to increase the amount of friction between the base portion and the toe portion of a boot of an operator, in such a way that, an operator, more easily, can kept the handheld tool in place on the ground, when for example, starting or adjusting the tool, it is possible for the operator to hold steady in the front handle and at the same time hold steady in the rear handle and place the toe portion of the boot on the base portion, to prevent the tool from slipping and it is possible for the operator to start and adjust the tool on the ground without slipping.

By arranging the support means of the rear portion with at least one supporting plate, arranged adjacent said at least one handle in such a way that an operator can lean the supporting plate against the thigh while operating the chain saw with the handle part, the operator can, in a comfortable way, press the thigh against the supporting plate and thereby in order to relieve the pressure on back, shoulders and arms and without slipping of the thigh.

In one embodiment of the invention the handle part comprises at least one front handle and at least one rear handle in order to make it easier for the operator to operate the tool. The base portion, having an under side and the rear portion are arranged adjacent the rear handle in such a way that the base portion and the rear portion forms one unit with the rear handle.

By arranging the support means on the base portion and/or the rear portion and since they are arranged close to the rear handle a handle part for a tool that is smooth and easy to operate is achieved. The support means prevents the operator from slipping of the thigh when pushing the thigh towards there rear part and from slipping of the base portion when putting a toe portion of a shoe on the base portion.

By providing support means which comprises at least one protruding portion that protrudes at least 1 mm from the surrounding surface of the base portion and preferably at least 2 mm or 3 mm a safe and effective anti-slip protection is achieved.

By arranging the protruding portion to comprise at least one rib and preferably two or three ribs the means is covering a large area and is thereby very effective.

In one embodiment the protruding portion comprises at least one spike and preferably two or three spikes which is another way of achieving an effective anti-slip protection.

In one embodiment of the invention the friction means comprises grip tape which can provide an effective anti-slip protection.

By providing a second friction means arranged on the under side of the base portion the friction between the base portion and the ground increases and the tool is thereby more stable when pressing it to the ground.

In one embodiment the second friction means comprises at least one protruding portion that protrudes at least 1 mm from the surrounding surface and preferably at least 2 mm or 3 mm.

The protruding portion of the second friction means may in one embodiment of the invention be arranged as at least one rib in order to cover as large area as possible and thereby increase the friction between the ground and the under side.

By providing the rear portion with a substantially plane surface, defining a plane, said surface having a width of approximately between 30 mm and 100 mm, a well formed and quite broad surface is provided that increases the comfort of the user when holding or pressing the thigh against the rear part of the handle part in order to relieve the pressure on back, shoulders and arms. By arranging the support means adjacent said handle in such a way that an operator can lean the support means against the thigh while operating the chain saw with the handle part, a more comfortable way of working during under cut is achieved.

In one embodiment of the invention the width of the surface of the rear portion, approximately, is between 45 mm and 85 mm, preferably between 50 mm and 70 mm.

In one embodiment of the invention the rear portion is inclined in such a way that an angle, is formed between the plane of the rear portion and a plane of the under side of the base portion in order to find a comfortable working position for the operator.

In one embodiment the angle, is between 20° and 70°. In another embodiment the angle is between 30° and 60°. In yet another embodiment the angle is between 40° and 50°, preferably 45°.

By providing the support means of the rear portion with at least one elongated groove you prevent the tool from slipping of the thigh of an operator. At the same time less material is needed and thick plastic material is avoided.

In one embodiment the support means is a support surface and the elongated groove is provided in that surface resulting in the same advantages as above.

The support surface is arranged with a convex contact surface in order to make it more comfortable for the operator, since a convex surface have no sharp edge.

In one embodiment the support means is made of a flexible material, such as rubber like material, by making the out of rubber material or coat them with rubber material very good anti-slip qualities are achieved.

In one embodiment the support means is arranged to the rear portion by means of welding. In another embodiment the support means is arranged to the rear portion by means of casting. Different types of techniques can be used in order to achieve a durable arrangement.

By arranging the support means as a support plate which plate is detachably arranged to the rear portion, in such a way that it can be removed and replaced, the support means can be changed for example when it is worn or broken.

In yet another embodiment the support surface is adjustably arranged to the rear portion with a pivoted axle, in such a way that the surface of the support surface bear on the thigh of an operator, and follows the movements of the operator when the operator pushes the thigh against the support surface while operating the tool this would make the support surface even more flexible and thereby comfortable for the operator.

The handle part with the support means of the invention can with advantage be arranged on a chain saw.

### BRIEF DESCRIPTION OF THE DRAWINGS

In the following, the invention will be described in more detail with reference to preferred embodiments and the accompanying drawings.

FIG. 1 schematically illustrates a perspective view of a chain saw having a handle part with friction means according to the invention.

FIG. 2 schematically illustrates a perspective view from above of a handle part with a first friction means according to the present invention.

FIG. 3a schematically illustrates a portion of the handle part shown in FIG. 2, provided with friction means according to one embodiment of the present invention.

FIG. 3b schematically illustrates portion of a handle part provided with friction means according to another embodiment of the present invention.

FIG. 3c schematically illustrates portion of a handle part provided with friction means according to yet another embodiment of the present invention.

FIG. 3d schematically illustrates portion of a handle part provided with friction means according to still yet another embodiment of the present invention.

FIG. 4 schematically illustrates a view from underneath of a chain saw having a handle part, wherein second friction means are provided according to one embodiment of the invention.

FIG. 5 schematically illustrates a front view of a chain saw having a handle part, provided with friction means according to one embodiment of the invention.

FIG. 6 schematically illustrates a side view of a chain saw having a handle part showing the angle A between an underside of the handle part and a rear portion of the handle part according to one embodiment of the invention.

FIG. 7 schematically illustrates an operator leaning the rear part of a chain saw against the thigh.

FIG. 8 schematically illustrates an operator putting a toe portion of a boot against the base portion of a chain saw when starting the chain saw from the ground.

### DETAILED DESCRIPTION OF PREFERRED EMBODIMENTS

The present invention will be described more fully hereinafter with reference to the accompanying drawings, in which preferred embodiments of the invention are shown. The invention may, however, be embodied in many different forms and should not be construed as limited to the embodiments set forth herein, rather, these embodiments are provided so that this disclosure will be thorough and complete, and will fully convey scope of the invention to those skilled in the art. In the drawings, like numbers refer to like elements.

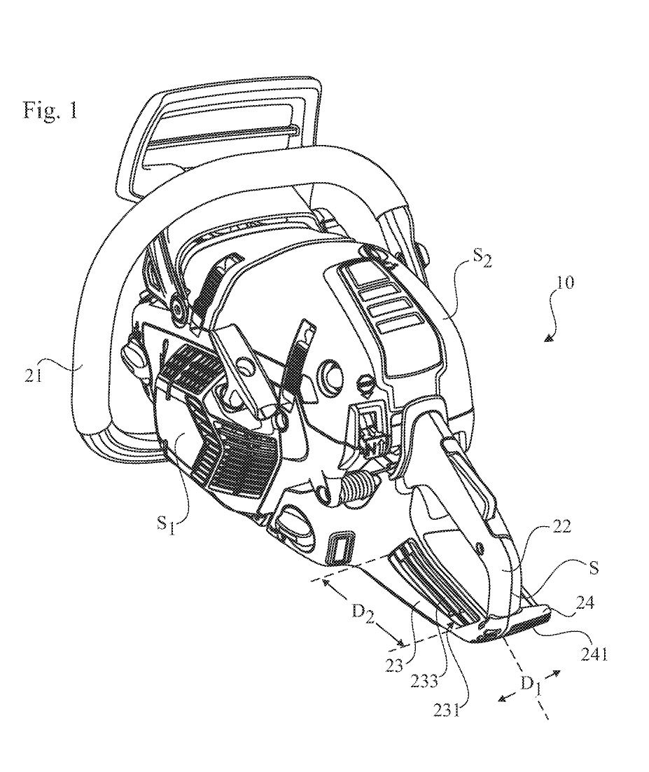

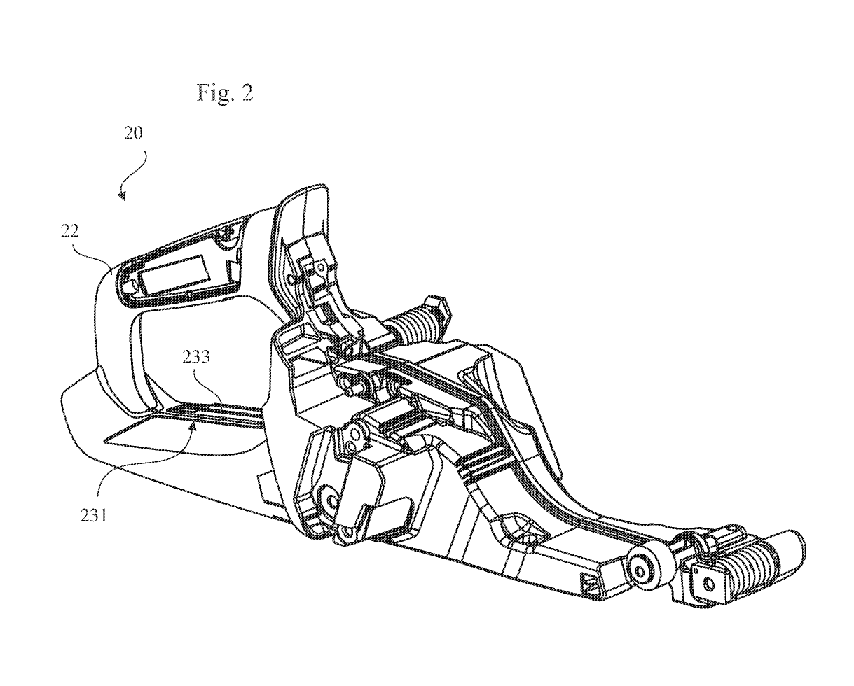

In FIG. 1 a motorized, handheld tool 10 is shown, in this case a chain saw. In FIG. 2 a handle part 20 for a chain saw 10 is shown. The chain saw 10 is adapted to be arranged with a drive unit comprising an engine, a saw bar and a chain (not shown). Many handheld tools, such as chain saws, employ the two-mass principle, wherein the handle part 20 and a fuel tank are separated from the engine. The chain saw 10 is arranged with a clutch side S₂ and a flywheel side S₁. The engine base includes the engine with its movable parts, a centrifugal clutch to the chain, a chain brake and a kickback guard. The handle part 20 comprises a front handle 21. The handle part 20 comprises a rear 22 handle. The rear handle 22 is in general formed integrally with a fuel tank, for operating fluid, such as fuel or oil, in the handle part 20, preferably from plastic material. The words “front” and “rear” are used to designate relative locations along longitudinal axis of a handheld power tool, such as a chain saw, for example. in a chain saw, the saw chain guide bar is located at front and of the saw, while the opposite end is rear end of the saw. The handle part 20 is manufactured by injection moulding in two separate parts, which are not necessarily identical, but which are intended to be joined together along a circumferential line S, see FIG. 1. D₁ in FIG. 1, is showing the dividing direction for the separate parts of the handle part 20 from a moulding tool.

The handle part 20 further has at least one base portion 23. The base portion 23 is preferably arranged adjacent the rear handle 22. The base portion 23 is with advantage arranged on the flywheel side S₁. The base portion 23 may be arranged correspondingly on the clutch side S₂. The base portion 23 is arranged adjacent the rear handle 22 in such a way that a toe portion, of a boot or the like of an operator, may be held against the base portion 23 when the chain saw 10 is placed on the ground.

The handle part 20 further comprises at least one rear portion 24. The rear portion 24 is arranged where the base plate 23 and the rear handle 22 meet. The rear portion 24 is arranged in such a way that a thigh of an operator may be held against the rear portion 24 when operating the chain saw 10. The base portion 23 has an under side 25. The rear portion 24 and the base portion 23 forms one unit with the rear handle 22.

In one embodiment of the invention the base portion 23 is provided with at least one support means 231 in order to facilitate the handling of the tool 10, in such a way that, an operator, more easily, can operate the tool 10 and more easily can keep the tool 10 in place on the ground when, for example, starting or adjusting the tool 10.

In another embodiment of the invention the rear portion 24 is provided with at least one support means 241 in order to facilitate the handling of the tool 10, in such a way that, an operator, more easily.

In yet another embodiment of the invention both the base portion 23 and the rear portion 24 is provided with at least one support means 231 and 241 respectively, in order to facilitate the handling of the tool 10, in such a way that, an operator, more easily, can operate the tool 10 and more easily can keep the tool 10 in place on the ground when, for example, starting or adjusting the tool 10.

The support means 231 arranged to be provided at the base portion 23 comprises at least one protruding portion 232 that protrudes at least 1 mm from the surrounding surface of the base portion 23 and preferably at least 2 mm or 3 mm. The support means 231 is arranged such that it extends over a considerable part of the base portion. The support means 23 extends according to D₂, see FIG. 1. FIG. 1 also shows that the extending directions D₂ of the protruding portion 231 in FIG. 1 is substantially perpendicular to the dividing direction D1. The protruding portion 232 of the support means 231 may be made of the same material as the surrounding surface of the base portion 23, i.e. some kind of plastic material. The protruding portion 232 of the support means 231 may also be made of a differing material, for example rubber or the like or other for the purpose suitable materials with advantage with anti-slip qualities.

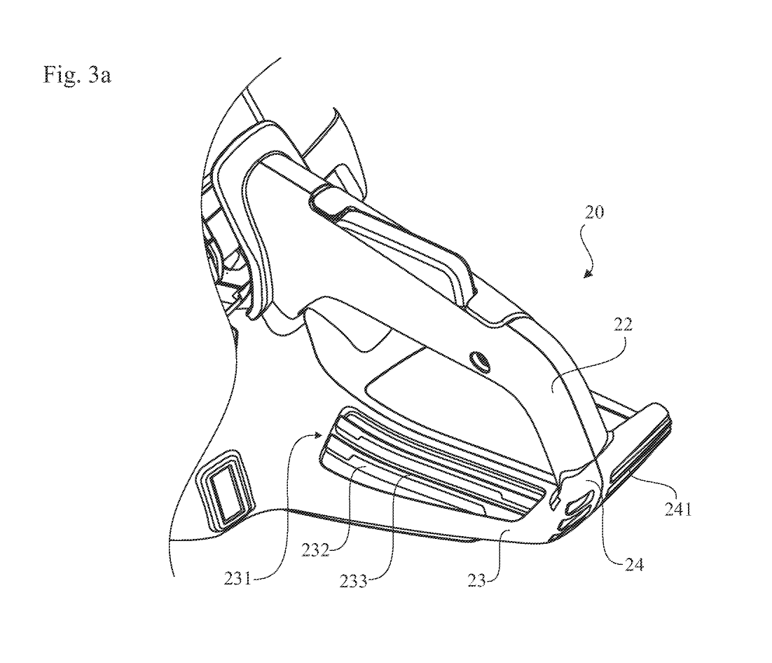

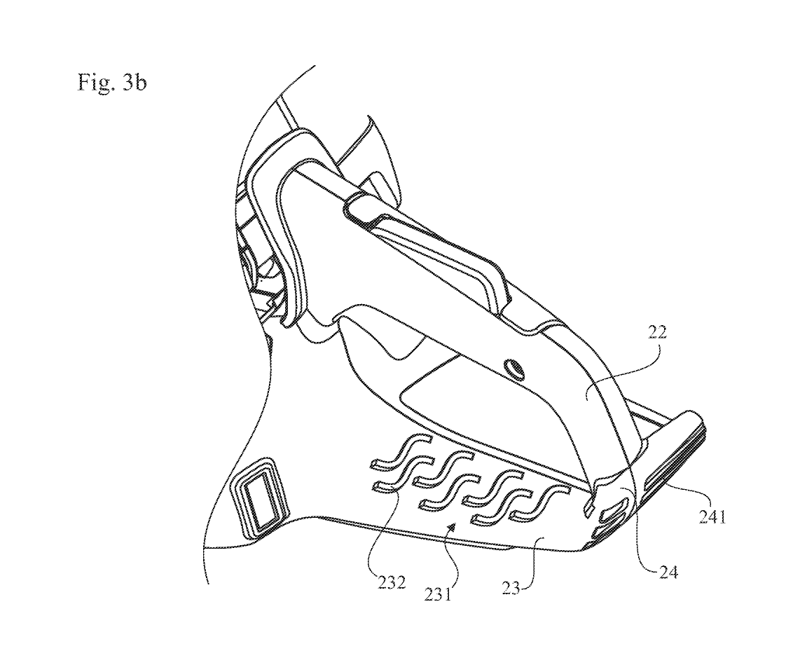

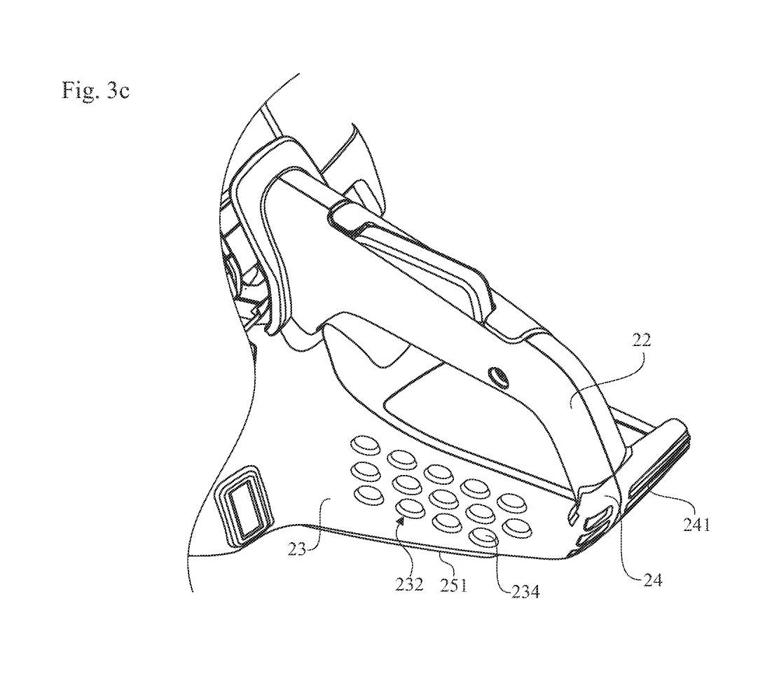

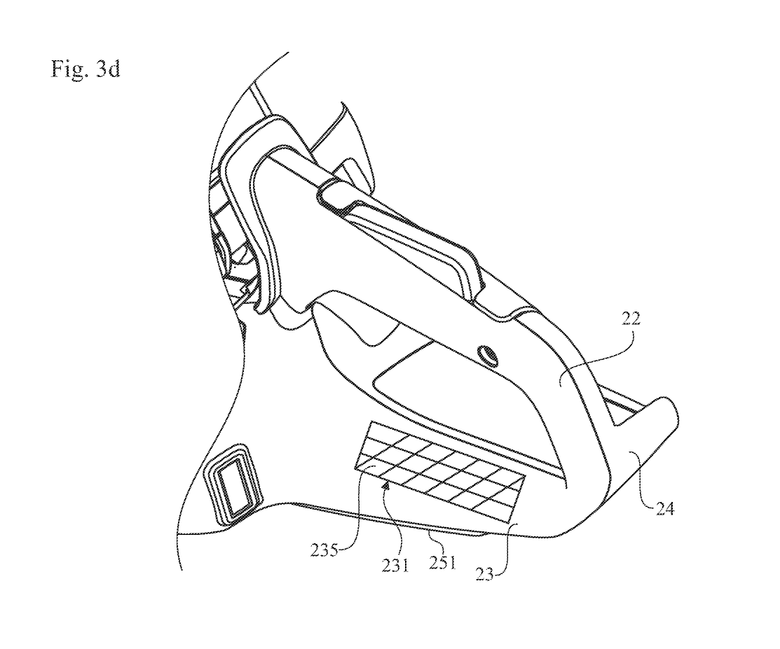

In one embodiment the protruding portion 232 comprises at least one rib 233 and preferably two or three ribs 233, see FIG. 3a. The protruding portion 232 may also have other shapes such as wave-shape, see FIG. 3b.

The protruding portion 232 may also comprise at least one spike 234 and preferably two or three spikes 234, see FIG. 3c.

In yet another embodiment the friction means 231 may comprise grip tape 235, see FIG. 3d.

The under side 25 of the base portion 23 is provided with a second friction means 251, for increasing the friction between the base portion 23 and the ground.

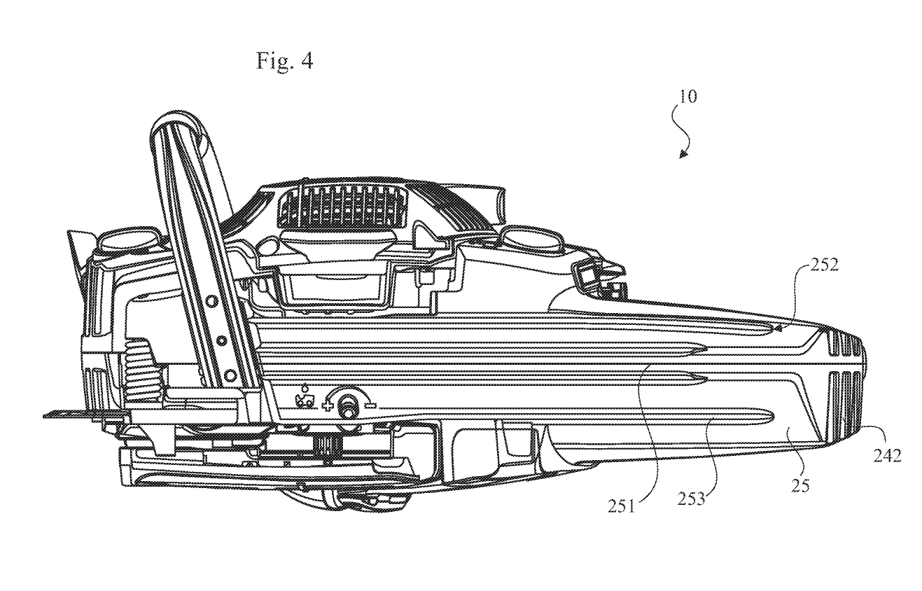

The second friction means 251 comprises at least one protruding portion 252 that protrudes at least 1 mm from the surrounding surface and preferably at least 2 mm or 3 mm, see FIGS. 3c, 3d and 4. In one embodiment the protruding portion 252 of the second friction means 251 is at least one rib 253, but it can also have other for the purpose suitable forms. The protruding portion 252 of the second friction means 252 may be made of the same material as the surrounding surface of the underside 25, i.e. some kind of plastic material. The protruding portion 252 may also be made of a differing material for example rubber or other for the purpose suitable materials.

The rear portion 24 has a substantially plane surface, defining a plane.

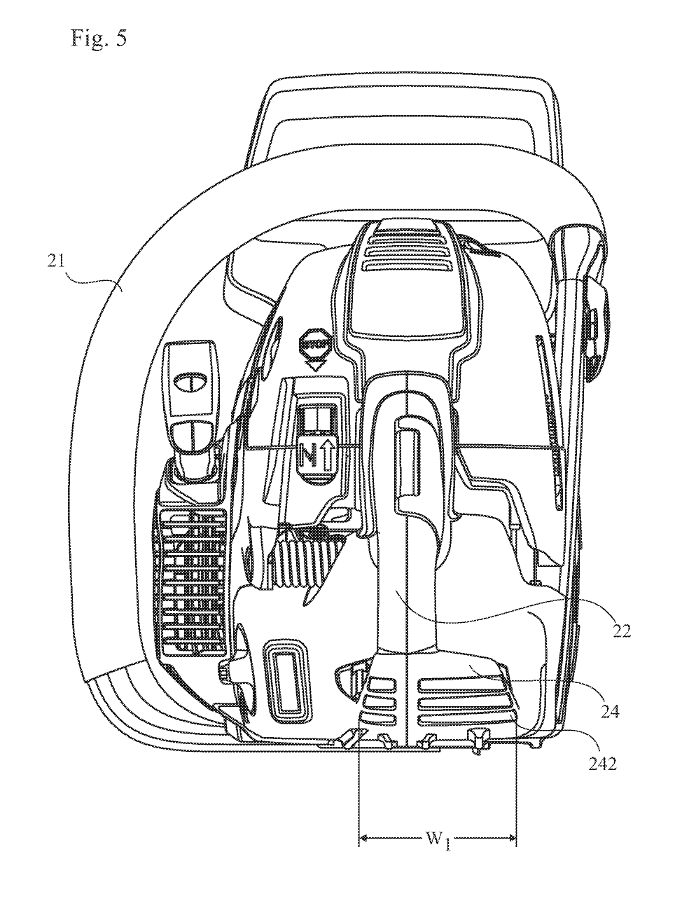

The surface has a width W₁, see FIG. 5, of approximately between 30 mm and 100 mm. The width W₁ is defining the broadest part of the rear portion 24. Preferably the width W₁ of the surface of the rear portion 24 is between 45 mm and 85 mm, more preferably between 50 mm and 70 mm. and most preferably between 60 mm and 65 mm.

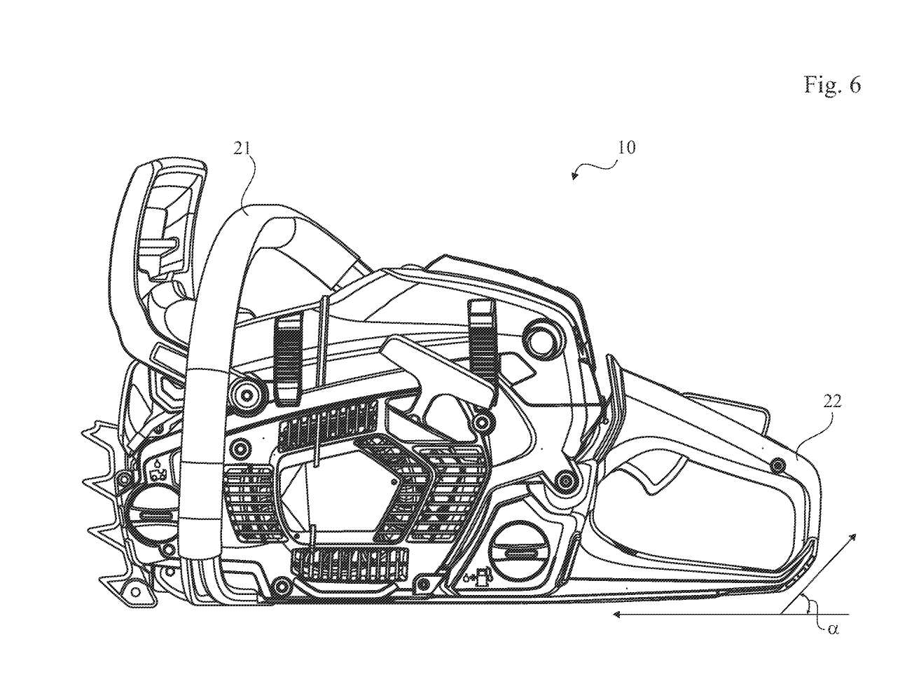

The rear portion 24 is inclined in such a way that an angle α, is formed between the plane of the rear portion and a plane of the under side 25 of the base portion 23, see FIG. 6.

The angle α, is between 20° and 70°, preferably between 30° and 60°, more preferably between 40° and 50°, and most preferably 45°. An angle α between 20° and 70° makes the support surface 241 formed in such a way that it is more comfortable for the user to put a thigh against. The support means 241 of the rear portion 24 is arranged with at least one elongated groove 242. The support surface 241 of the rear portion 24 is arranged with at least one elongated groove 242. The support surface 241 is further arranged with a convex contact surface which also provides a support surface 241 that is formed in such a way that it is more comfortable for the user to put a thigh against.

The support means 231, 241 may be made of plastic material as the rest of the handle part 20 or of for example a flexible material, such as rubber like material or other for the purpose suitable materials.

The support means 241 may be arranged to the rear portion 24 by means of welding or casting or using other for the purpose suitable techniques.

In one embodiment the support surface 241 is arranged as a support plate which plate is detachably arranged to the rear portion 24, in such a way that it can be removed and replaced. The support surface 241 may be adjustably arranged to the rear portion 24 with a pivoted axle, in such a way that the surface of the support surface 241 bear on the thigh of an operator, and follows the movements of the operator when the operator pushes the thigh against the support surface 241 while operating the tool 10.

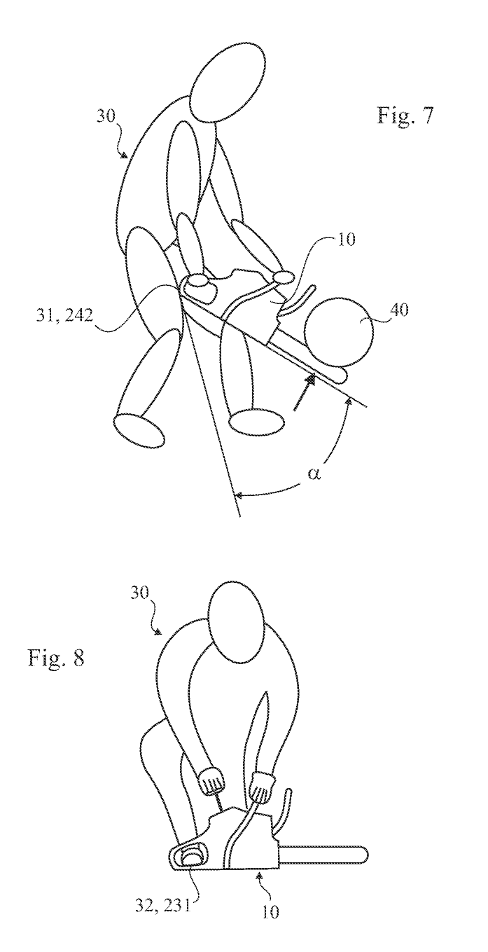

FIG. 7 shows an operator 30 using an undercut, lifting the saw 10 towards a log 40. The operator pushes the rear part 24 of the saw 10, such that a contact surface is achieved between a thigh 31 of the operator 30 and the support means 241 of the rear portion. When the undercut starts the angle α defines the relationship between the rear portion 24 and the underside 25 of the base portion 23, this angle may then change as the undercut proceeds. Correspondingly the angle α is shown in FIG. 6, showing that an angle α of approximately 45° is achieved since the inclined surface of the rear portion 24, making the tool 10 much more comfortable to operate. This in combination with the width W₁ of the rear portion that in its widest portion is approximately between 60 mm-65 mm achieving a very comfortable contact surface towards the thigh 31 of an operator 30.

FIG. 8 shows an operator 30 starting a chain saw 10 on the ground putting a toe portion of a boot 32 on the base portion 23, such that a contact surface is achieved between the toe portion of the boot 32 and the support means of the base portion 23.

The support means can be arranged on other types of handheld tools, such as power cutters, trimmers, hedge trimmers and pole saws. The tool may be battery-powered, electrically-driven or petrol-driven or driven by other for the purpose suitable types of fuel.

1. A handle part for a motorized, handheld tool, having at least one handle, for an operator to carry and operate the tool, said handle part further having;
at least one base portion arranged adjacent said at least one handle in such a way that a toe portion, of a foot of an operator, may be held against the base portion when the tool is placed on the ground, and
at least one rear portion arranged where the base portion and said at least one handle meet, in such a way that a thigh of the operator may be held against the rear portion when operating the tool,
wherein at least one of, the base portion and the rear portion, is provided with at least one support means in order to facilitate the handling of the tool, in such a way that, the operator is enabled to operate the tool and keep the tool in place on the ground when starting or adjusting the tool.

2. Handle part, according to claim 1, wherein said at least one support means is provided at the base portion and wherein the support means is a first friction means in order to increase the amount of friction between the base portion and the toe portion of the foot of the operator, in such a way that, the operator is enabled to keep the tool in place on the ground, when starting or adjusting the tool.

3. Handle part, according to claim 1, wherein said at least one support means is provided at the rear portion and wherein the support means is at least one support surface, arranged adjacent said at least one handle in such a way that the operator is enabled to lean the support surface against the thigh while operating the tool with the handle part.

4. Handle part, according to claim 1, wherein the handle part comprises at least one front handle and at least one rear handle, and wherein the base portion, having an under side, and the rear portion are arranged adjacent the rear handle in such a way that the base portion and the rear portion forms one unit with the rear handle.

5. Handle part, according to claim 1, wherein the support means comprises at least one protruding portion that protrudes at least 1 mm from the surrounding surface of the base portion and preferably at least 2 mm or 3 mm.

6. Handle part, according to claim 5, wherein the protruding portion comprises at least one rib and preferably two or three ribs.

7. Handle part, according to claim 5, wherein the protruding portion comprises at least one spike and preferably two or three spikes.

8. Handle part, according to claim 2, wherein the friction means comprises grip tape.

9. Handle part, according to claim 1, wherein an under side of the base portion is provided with a second friction means, for increasing the friction between the base portion and the ground.

10. Handle part, according to claim 9, wherein the second friction means comprises at least one protruding portion that protrudes at least 1 mm from the surrounding surface and preferably at least 2 mm or 3 mm.

11. Handle part, according to claim 10, wherein the protruding portion of the second friction means is at least one rib.

12. Handle part, according to claim 1, wherein said rear portion has a substantially plane surface, defining a plane, said surface having a width (W₁) of between 30 mm and 100 mm.

13. Handle part, according to claim 12, wherein the width (W₁) of the surface of the rear portion is between 45 mm and 85 mm, preferably between 50 mm and 70 mm.

14. Handle part, according to claim 12, wherein the rear portion is inclined in such a way that an angle (α), is formed between the plane of the rear portion and a plane of the under side of the base portion.

15. Handle part, according to claim 14, wherein the angle (α), is between 20° and 70°.

16. Handle part, according to claim 14, wherein the angle (α), is between 30° and 60°.

17. Handle part, according to claim 14, wherein the angle (α), is between 40° and 50°, preferably 45°.

18. Handle part, according to claim 1, wherein the support means of the rear portion is arranged with at least one elongated groove.

19. Handle part, according to claim 3, wherein the support surface of the rear portion is arranged with at least one elongated groove.

20. Handle part, according to claim 3, wherein the support surface is arranged with a convex contact surface.

21. Handle part, according to claim 1, wherein the support means are made of a flexible material.

22. Handle part, according to claim 1, wherein the support means is arranged to the rear portion via welding.

23. Handle part, according to claim 1, wherein the support means is arranged to the rear portion via casting.

24. Handle part, according to claim 1, wherein the support means is arranged as a support plate which plate is detachably arranged to the rear portion, in such a way as to enable the plate to that it can be removed and replaced.

25. Handle part, according to claim 3, wherein the support surface is adjustably arranged to the rear portion with a pivoted axle, in such a way that the surface of the support surface bears on the thigh of the operator, and follows the movements of the operator when the operator pushes the thigh against the support surface while operating the tool.

26. Handle part, according to claim 1, wherein the motorized, handheld tool, is a chain saw.
